(19) United States
(12) Patent Application Publication
(10) Pub. No.: US 2020/0102109 A1
(43) Pub. Date: Apr. 2, 2020

(54) APPARATUS TO FACILITATE BAGGING

(71) Applicant: Mark Mondrone, Bound Brook, NJ (US)

(72) Inventor: Mark Mondrone, Bound Brook, NJ (US)

(21) Appl. No.: 16/148,095

(22) Filed: Oct. 1, 2018

(51) Int. Cl. B65B 67/12; F16M 11/32

(52) U.S. Cl. CPC B65B 67/1205; F16M 11/32; B65B 67/1233

(57) ABSTRACT

An apparatus to facilitate bagging of a bag, the apparatus including an upper ring having a first circumference, the upper ring being disposed parallel to a ground surface, a center ring having a second circumference, the center ring being disposed below the upper ring, and a plurality of legs extending from a bottom surface of the upper ring towards the ground surface such that each of the plurality of legs contacts an inner circumferential surface of the center ring and a bottom surface of each of the plurality of legs contacts the ground surface.

### BACKGROUND

### 1. Field

The present general inventive concept relates generally to an apparatus to facilitate bagging.

### 2. Description of the Related Art

Standard contractor bags are often difficult to fill, and require one person who holds the bag, while another person fills it. Specifically, at present, if a person desires to fill a bag with debris in an expeditious manner, the person typically relies on another person to hold the bag, which can be tedious. Also, if there is only one person at a site, it may take a long time to fill a bag with trash/debris.

Therefore, there is a need for an apparatus to facilitate placing items in a bag.

### SUMMARY

The present general inventive concept provides an apparatus to facilitate bagging.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an apparatus to facilitate bagging of a bag, the apparatus including an upper ring having a first circumference, the upper ring being disposed parallel to a ground surface, a center ring having a second circumference, the center ring being disposed below the upper ring, and a plurality of legs extending from a bottom surface of the upper ring towards the ground surface such that each of the plurality of legs contacts an inner circumferential surface of the center ring and a bottom surface of each of the plurality of legs contacts the ground surface.

The center ring may be parallel to the upper ring.

A bag may be insertable within a center opening of the upper ring to pass through a center opening of the center ring.

Each of the plurality of legs may include a first leg portion to extend from the bottom surface of the upper ring towards the ground surface, and a second leg portion disposed at least partially within the first leg portion to extend out the first leg portion in a telescopic manner.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an apparatus to facilitate bagging, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

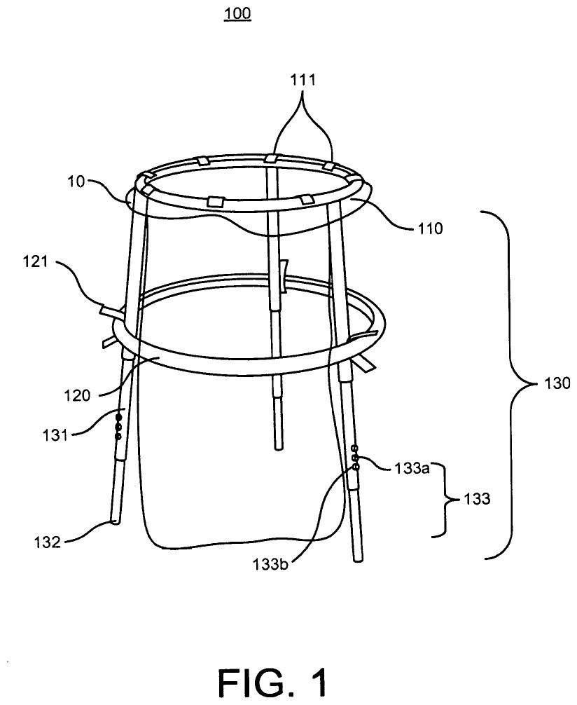

FIG. 1 illustrates an apparatus to facilitate bagging 100, according to an exemplary embodiment of the present general inventive concept.

Referring to FIG. 1, the apparatus to facilitate bagging 100 may include an upper ring 110, a center ring 120, and a plurality of legs 130, but is not limited thereto.

The upper ring 110 may include a plurality of detachable clips 111 disposed along a top circumferential surface thereof. The plurality of detachable clips 111 may be used to secure a bag 10 to the top circumferential surface of the upper ring 110.

The center ring 120 may be secured to the plurality of legs 130 via a plurality of attachment portions 121, which may be constructed from VELCRO, hooks, snaps, clasps, loops, or any other type of attachment devices.

As such, the center ring 120 may be disposed below the upper ring 110 to allow the apparatus to facilitate bagging 100 to be stable.

Also, the center ring 120 may have a circumference that is slightly larger than a circumference of the upper ring 110.

The plurality of legs 130 may include each include a first leg portion 131, a second leg portion 132, and a telescoping button portion 133.

The second leg portion 132 may be telescopic with respect to the first leg portion 131, such that the second leg portion 132 may extend outward from the first leg portion 131 to make the leg 130 longer or shorter based on a user's preference.

The telescoping button portion 133 may include a plurality of buttons 133a disposed on the second leg portion 132, and a plurality of apertures 133b disposed on the first leg portion 131, in order to allow the second leg portion 132 to remain locked in position with respect to the first leg 131 when the second leg portion 132 is extended out from the first leg portion 131.

As depicted in FIG. 1, the plurality of legs 130 may be provided as three legs, but may be provided as four, five, or more legs.

Therefore, the apparatus to facilitate bagging 100 of the bag 10 may include the upper ring 110 having a first circumference, the upper ring 110 being disposed parallel to a ground surface, the center ring 120 having a second circumference, the center ring 120 being disposed below the upper ring 110, and the plurality of legs 130 extending from a bottom surface of the upper ring 110 towards the ground surface such that each of the plurality of legs 130 contacts an inner circumferential surface of the center ring 120 and a bottom surface of each of the plurality of legs 130 contacts the ground surface.

The second circumference may be larger than the first circumference, but is not limited thereto.

The center ring 120 may be parallel to the upper ring 110.

The bag 10 may be insertable within a center opening of the upper ring 110 to pass through a center opening of the center ring 120.

Each of the plurality of legs 130 may include the first leg portion 131 to extend from the bottom surface of the upper ring 110 towards the ground surface, and the second leg portion 132 disposed at least partially within the first leg portion 131 to extend out the first leg portion 131 in a telescopic manner.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to facilitate bagging of a bag, the apparatus comprising:
an upper ring having a first circumference, the upper ring being disposed parallel to a ground surface;
a center ring having a second circumference, the center ring being disposed below the upper ring, such that the second circumference is larger than the first circumference; and
a plurality of legs extending from a bottom surface of the upper ring towards the ground surface such that each of the plurality of legs contacts an inner circumferential surface of the center ring and a bottom surface of each of the plurality of legs contacts the ground surface.

2. The apparatus of claim 1, wherein the center ring is parallel to the upper ring.

3. The apparatus of claim 1, wherein a bag is insertable within a center opening of the upper ring to pass through a center opening of the center ring.

4. The apparatus of claim 1, wherein each of the plurality of legs comprises:
a first leg portion to extend from the bottom surface of the upper ring towards the ground surface; and
a second leg portion disposed at least partially within the first leg portion to extend out the first leg portion in a telescopic manner.

5. An apparatus to facilitate bagging of a bag, the apparatus comprising:
an upper ring, comprising:
a plurality of detachable clips to secure the bag to a top circumferential surface of the upper ring;
a center ring disposed below the upper ring, the center ring comprising:
a plurality of attachment portions disposed on an inner circumferential surface of the center ring; and
a plurality of legs extending from a bottom surface of the upper ring towards the ground surface such that each of the plurality of attachment portions connect the plurality of legs to the center ring, such that each of the plurality of attachment portions protrude away from each of the plurality of legs, such that each of the plurality of attachment portions extends over and below at least a portion of the center ring.
